(19) United States
(12) Patent Application Publication
(10) Pub. No.: US 2016/0271500 A1
(43) Pub. Date: Sep. 22, 2016

(54) System and Method for Analyzing Data Associated with Electronic Games

(71) Applicant: HCL Technologies Limited, Uttar Pradesh (IN)

(72) Inventors: Chitranjan Nath, Uttar Pradesh (IN); Yogesh Gupta, Uttar Pradesh (IN)

(21) Appl. No.: 15/056,157

(22) Filed: Feb. 29, 2016

(30) Foreign Application Priority Data
Mar. 17, 2015 (IN) 730/DEL/2015

(51) Int. Cl. A63F 13/79

(52) U.S. Cl. CPC A63F 13/79

(57) ABSTRACT

Disclosed is a method (300) and system (102) for analyzing data associated with electronic games. The system (102) receives data associated with one or more types of electronic games from heterogeneous data sources, and the data is related to in-game activities performed by players playing electronic games. The system 102 normalizes the data into common schema to obtain normalized data and categorize normalized data into categories of electronic games to obtain categorized data, and classifies categorized data into sub-categories of the electronic games to obtain classified data. The system (102) partitions classified data based upon game attributes to generate partitioned data, and executes one or more analytical techniques on the partitioned data to obtain one or more user telemetry patterns related to in-game activities performed.

### CROSS-REFERENCE TO RELATED APPLICATIONS AND PRIORITY

The present application claims benefit from Indian Complete Patent Application No. 730/DEL/2015, filed on Mar. 17, 2015, the entirety of which is hereby incorporated by reference.

### TECHNICAL FIELD

The present subject matter described herein, in general, relates to data analytics, and more particularly to system and method for analyzing data associated with electronic games.

### BACKGROUND

As internet usage has tremendously increased in recent times, there has been continuous increase in development of variety of electronic games. While playing the variety of electronic games, game players interact with the games in numerous ways. While interacting with the electronic games, the game players generate huge amount of data related to the electronic games as well as their interests relating to gaming, for example, usability of the games, much liked features of the games, and the like. Gaming companies who develop the electronic games have interest in the data generated or shared by the game players continuously. The data generated by the game players may acts as useful source of information for deriving insights related to marketing, development, and production of the games. The statistics generated based on the data may help the gaming companies to identify sales trends and likeliness of game features.

The electronic games enable interactively engaging the people with contents associated with the electronic games and to enjoy playing the electronic games. The electronic games may be categorized into a few categories. The games that belong to a particular category usually have similar offerings with different names The gaming companies generate analytics on data generated for games that are owned by a particular gaming company and hence data is restricted to a user base that plays games owned by the particular gaming company. Further, as the data is restricted to user base that plays games owned by the particular gaming company, the types of the electronic games and features of the electronic games are also restricted. This restricted data statistics provides limited window for the gaming companies to improve the electronic games and also expand the user base.

Further, in order to tap new users, thorough analytics of in-game user behavior, and response of the game player while purchasing and utilizing in-game credit across variety of electronics games is needed. The gaming companies need to understand overall user sentiments across various games which are not available in present solutions.

### SUMMARY

This summary is provided to introduce aspects related to systems and methods for analyzing data associated with electronic games, and the aspects are further described below in the detailed description. This summary is not intended to identify essential features of the claimed subject matter nor is it intended for use in determining or limiting the scope of the claimed subject matter.

In one implementation, a method for analyzing data associated with electronic games is disclosed. The method comprises receiving, by a processor, data associated with one or more types of the electronic games from a plurality of heterogeneous data sources. The data is related to in-game activities performed by players playing the electronic games. The method further comprises normalizing, by the processor, the data into a common schema in order to obtain normalized data. The method further comprises categorizing, by the processor, the normalized data into a plurality of categories of the electronic games in order to obtain categorized data. The method further comprises classifying, by the processor, the categorized data into sub-categories of the electronic games in order to obtain classified data. The method further comprises partitioning, by the processor, the classified data based upon a plurality of game attributes to generate partitioned data. The method further comprises executing, by the processor, one or more analytical techniques on the partitioned data to obtain one or more user telemetry patterns related to the in-game activities performed.

In one implementation, a system for analyzing data associated with electronic games is disclosed. The system comprises a processor and a memory coupled to the processor. The processor is capable of executing programmed instructions stored in the memory to receive data associated with one or more types of electronic games from a plurality of heterogeneous data sources. The data is related to in-game activities performed by players playing the electronic games. The processor further normalizes the data into a common schema in order to obtain normalized data. The processor further categorizes the normalized data into a plurality of categories of electronic games in order to obtain categorized data. The processor further classifies the categorized data into sub-categories of the electronic games in order to obtain classified data. The processor further partitions the classified data based upon a plurality of game attributes to generate partitioned data. The processor further executes one or more analytical techniques on the partitioned data to obtain one or more user telemetry patterns related to the in-game activities performed.

In one implementation, a non transitory computer readable medium having embodied thereon a computer program executed in a computing device for analyzing data associated with electronic games is disclosed. The computer program comprises a program code for receiving data associated with one or more types of electronic games from a plurality of heterogeneous data sources. The data is related to in-game activities performed by players playing the electronic games. The computer program further comprises a program code for normalizing the data into a common schema in order to obtain normalized data. The computer program further comprises a program code for categorizing the normalized data into a plurality of categories of electronic games in order to obtain categorized data. The computer program further comprises a program code for classifying the categorized data into sub-categories of the electronic games in order to obtain classified data. The computer program further comprises a program code for partitioning the classified data based upon a plurality of game attributes to generate partitioned data. The computer program further comprises a program code for executing one or more analytical techniques on the partitioned data to obtain one or more user telemetry patterns related to the in-game activities performed.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for analyzing data associated with electronic games, in accordance with an embodiment of the present subject matter.

FIG. 2 illustrates functional architecture of the system for analyzing the data associated with the electronic games, in accordance with an embodiment of the present subject matter.

FIG. 3 illustrates a method for analyzing data associated with electronic games, in accordance with an embodiment of the present subject matter.

### DETAILED DESCRIPTION

Systems and methods for analyzing data associated with electronic games are described. The present disclosure enables an effective and efficient mechanism for analyzing data associated with the electronic games. The data associated with one or more types of the electronic games may be received from a plurality of heterogeneous data sources. The data may be related to in-game activities performed by players playing the electronic games. In one embodiment, the data may be associated with in-game credit purchasing and utilization of the credit. The present disclosure facilitates gaming companies to analyze purchase and usage of in-game credit, by the game players, playing the electronic games in order to understand overall user (game player) sentiments associated with the electronic games. Further, the overall user sentiments may be used to tap new users (game players).

After receiving the data, the data may be normalized into a common schema in order to obtain normalized data. The normalized data may be further categorized into a plurality of categories of the electronic games in order to obtain categorized data. The categorized data may be further classified into sub-categories of the electronic games in order to obtain classified data. The classified data may be further partitioned based upon a plurality of game attributes to generate partitioned data. Further, one or more analytical techniques may be executed on the partitioned data to obtain one or more user telemetry patterns related to the in-game activities performed.

While aspects of described system and method for analyzing data associated with electronic games may be implemented in any number of different computing systems, environments, and/or configurations, the embodiments are described in the context of the following exemplary system.

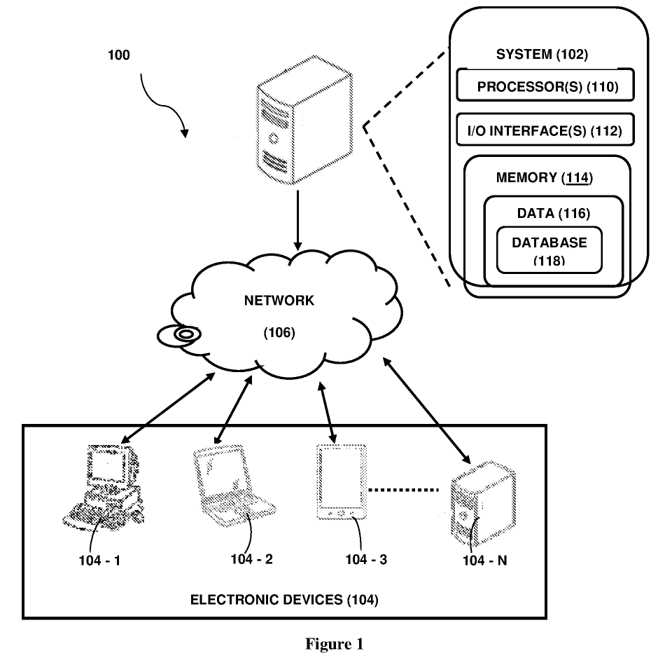

Referring now to FIG. 1, a network implementation 100 of a system 102 for analyzing data associated with electronic games is illustrated, in accordance with an embodiment of the present subject matter. In one embodiment, the system 102 may receive data associated with one or more types of the electronic games from a plurality of heterogeneous data sources. The data may be related to in-game activities performed by players playing the electronic games. In one embodiment, the system 102 may normalize the data into a common schema in order to obtain normalized data. Post normalizing, the system 102 may further categorize the normalized data into a plurality of categories of the electronic games in order to obtain categorized data. Post categorizing, the system 102 may further classify the categorized data into sub-categories of the electronic games in order to obtain classified data. Subsequent to classification, the system 102 may further partition the classified data based upon a plurality of game attributes to generate partitioned data. Post partitioning, the system 102 may execute one or more analytical techniques on the partitioned data to obtain one or more user telemetry patterns related to the in-game activities performed.

Although the present subject matter is explained considering that the system 102 is implemented on a server, it may be understood that the system 102 may also be implemented in a variety of computing systems, such as a laptop computer, a desktop computer, a notebook, a workstation, a mainframe computer, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, gaming console, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

Referring now to FIG. 1, the system 102 is illustrated in accordance with an embodiment of the present subject matter. In one embodiment, the system 102 may include at least one processor 110, an input/output (I/O) interface 112, and a memory 114. The at least one processor 110 may be implemented as one or more microprocessors, microcomputers, microcontrollers, digital signal processors, central processing units, state machines, logic circuitries, and/or any devices that manipulate signals based on operational instructions. Among other capabilities, the at least one processor 110 is configured to fetch and execute computer-readable instructions stored in the memory 114.

The I/O interface 112 may include a variety of software and hardware interfaces, for example, a web interface, a graphical user interface, and the like. The I/O interface 112 may allow the system 102 to interact with a user directly or through the client devices 104. Further, the I/O interface 112 may enable the system 102 to communicate with other computing devices, such as web servers and external data servers (not shown). The I/O interface 112 can facilitate multiple communications within a wide variety of networks and protocol types, including wired networks, for example, LAN, cable, etc., and wireless networks, such as WLAN, cellular, or satellite. The I/O interface 112 may include one or more ports for connecting a number of devices to one another or to another server.

The memory 114 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 114 may include the programmed instructions and data 116.

The data 116, amongst other things, serves as a repository for storing data processed, received, and generated by execution of the programmed instructions. The data 116 may also include a system database 118.

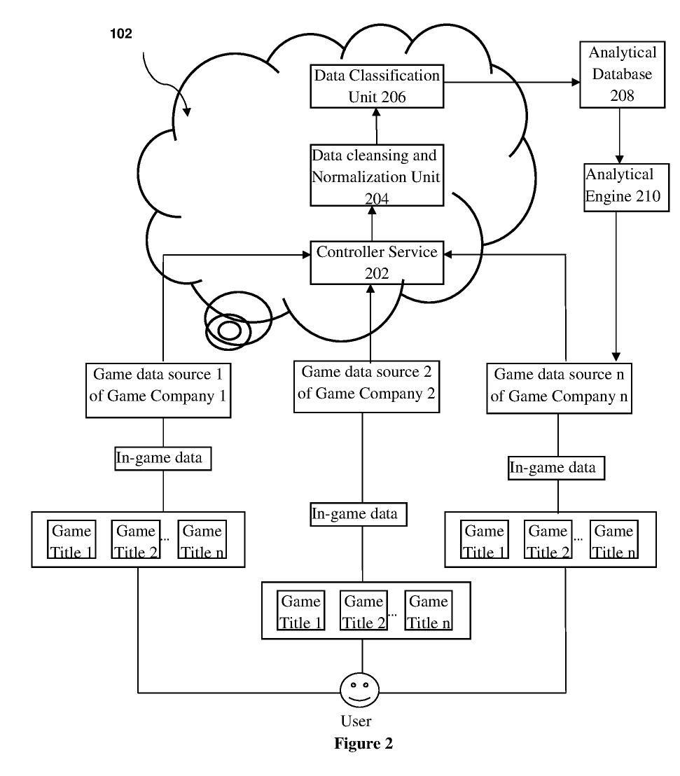

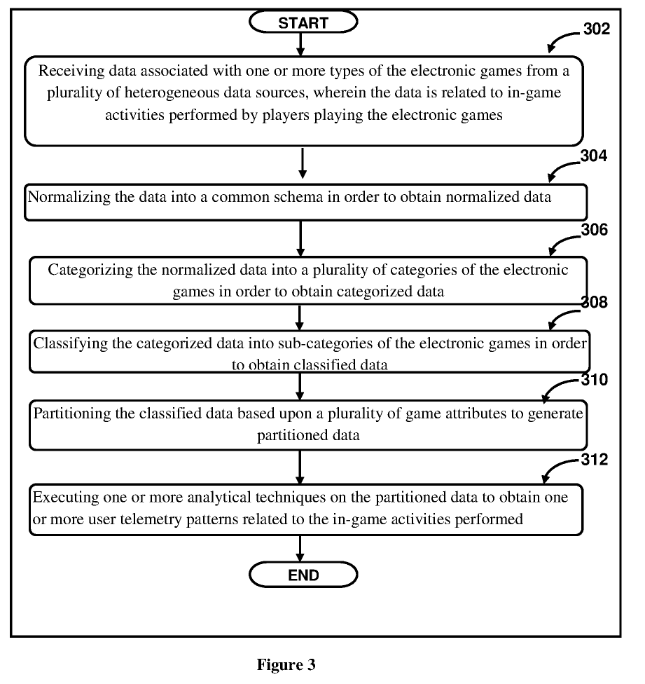

In one implementation, at first, a user may use the client device 104 to access the system 102 via the I/O interface 112. The user may register using the I/O interface 112 in order to use the system 102. The working of the system 102 may be explained in detail in FIGS. 2 and 3 explained below. The system 102 may be used for analyzing the data associated with the electronic games. FIG. 2 illustrates functional architecture of the system 102 for analyzing the data associated with the electronic games, in accordance with an embodiment of the present subject matter.

Referring to FIG. 2, functional architecture of the system 102 is described below. Referring to the functional architecture of the system 102, working of the system 102 is described. In one embodiment, referring to FIG. 2, in order to analyze data associated with electronic games, the system 102 may receive data associated with one or more types of the electronic games. The system 102 may receive the data from a plurality of heterogeneous data sources. As shown in FIG. 2, the system 102 may receive data from one or more game companies having data source 1, data source 2, and data source 3 . . . data source n. In one embodiment, the data may be related to in-game activities performed by players playing the electronic games. The data may comprise amount of in-game credit purchased for plurality of categories, sub-categories and game attributes, amount of in-game credit used for plurality of categories, sub-categories, and game attributes, geographical location of a user, region of the user, date of purchase of a game, age of the user, mode of payment used while purchasing the in-game credit. However, the data may not be restricted to content as described above. The data may be any type of data associated with the electronic games. The data may be data of any type known to a person skilled in the art. In one embodiment, the in-game activities may be related to at least one of purchase and usage of in-game credit.

As the data may be received from the plurality of heterogeneous data sources, the data may not be in similar format and the data may be present in a dissimilar pattern and dissimilar formats. Hence, the data need to be formatted into a single or common format. Hence in order to bring the data in the common format (schema), the data may be normalized. Post receiving the data, the data may be normalized into a common schema in order to obtain normalized data. Data normalization is the process of organizing the data in order to minimize or remove dissimilarity in the data and bringing the data in a single format. The data normalization technique may be selected from 1NF, 2NF, 3NF or BCNF and the like. The data normalization technique may not be limited to the normalization techniques as mentioned above and the data normalization techniques may include the data normalization techniques known to a person skilled in the art. In one embodiment, the data may be collected for a variety of electronic game categories and the data may be normalized on harmonization of different gaming attributes as captured by different gaming companies for electronics games of same categories. The normalization technique may be selected based on complexity of the data.

In an embodiment, the normalization of the data is explained using an example. In this example, assume an electronic game belongs to a category of medieval war games. The gaming companies developing the medieval war games captures data for credits spent on various types of fighting arms and defense items as available in game stores. The fighting arms and the defense items are purchased for a credit price as defined within the electronic game. Further, game data for the electronics games of similar category to the medieval war games are also captured from multiple other gaming companies, stored in plurality of data sources. The data so received is subjected to normalization algorithms that harmonize credit price and game purchase data. In the present disclosure, ‘game’ is to be treated as an ‘electronics game’.

Post normalization, the system 102 may categorize the normalized data into a plurality of categories of the electronic games in order to obtain categorized data. The plurality of categories of the electronic games may comprises various types of electronics games comprising software games, teletype games, electronic handheld games, pinball machines and similar device games, redemption games, merchandisers, slot machines, audio games, video games, arcade games, computer video games, console games, educational games, electromechanical games, non-human games and the like. The electronics games as listed above may not be limited to as described above and may include any type of electronic game known to a person skilled in the art. Further, in one example the categories of the electronic games may include action games, sports games, puzzles, quiz games, adventure games, racing games, strategically games, War games, solo fight games, board games, Mission games, Athletic games, and the like.

Post categorization, the system 102 may classify the categorized data into sub-categories of the electronic games in order to obtain classified data. In one embodiment, data of a category may be further divided into sub-categories. In one example, the subcategories of the categories may comprise for example, for strategically games the sub-categories may include military strategy games, fantasy strategy games, sci-fi strategy games, sports management games and the like. In one example, the action games may include sub-categories such as first person action adventure games, third person action adventure games, isometric platform games, open world action games, platform adventure games, role playing, stealth and racing games and the like.

Post classification, the system 102 may partition the classified data based upon a plurality of game attributes to generate partitioned data. In one embodiment, data of a sub-category may be further classified based on the plurality of game attributes. In an embodiment, the plurality of game attributes for a particular sub-category of the electronic game is explained using an example. In this example, the sub-category of third person action adventure games may be further classified upon game attributes such as fictional models of American cities, hand to hand combat, stealth, historical fiction and the like. Examples of classification of category further to sub category, and further partitioning of sub category to game attributes are 1) War Games→Medieval War Games→Offence→Swords→Two sided, for 2) Sports Game→Water→Swimming→Free style→Power Boost.

Post partitioning, the system 102 may execute one or more analytical techniques on the partitioned data to obtain one or more user telemetry patterns related to the in-game activities performed. For example, the one or more analytical techniques may be selected from k-means, Item-Based Collaborative Filtering, Statistical Mean, Correlation and the like. The one or more analytical techniques may be any analytical technique known to a person skilled in the art.

In one implementation, since the normalized data may be classified across the plurality of categories, sub-categories and game attributes, the one or more user telemetry patterns obtained from so classified data are more detailed, accurate, factual, and specific. Hence, the one or more user telemetry patterns may provide a thorough analysis of user sentiments across the plurality of the electronic games particularly in terms of the categories, sub-categories and the game attributes.

In one embodiment, referring to FIG. 2, the implementation of the system 102 is described below. The system 102 may be implemented for bulk capturing of data related to purchase and usage of game credit. In one embodiment, the system 102 may be hosted on cloud as shown in FIG. 2, and may be supported by a plurality of gaming companies to provide the data related to purchase and usage of game credit. In one example, as shown in FIG. 2, the system 102 may be supported with Game data source 1 of Game Company 1, Game data source 2 of Game Company 2 and up to Game data source n of Game Company n. Further the Game data source 1, Game data source 2 . . . up to Game data source n contains in-game data associated with Game Title 1, Game Title 2, up to Game Title n.

The data related to purchase and usage of game credit may be associated with plurality of users. The plurality of users may be game players. The data related to purchase and usage of the game credit may be captured with details of the user like, geographical location, region, date of purchase, age of the user, mode of payment, and the like.

In one embodiment, the system 102 may have a controller service 202 for capturing the data. The controller service may maintain a queue of requests, create job ID for each request, manage a job for each job ID, manage rules for each job, and may handle query operations to fetch the data in order to feed database. When the controller service receives a job execution request, the controller service may normalize the data to obtain normalized data, and may update tables in the database accordingly by using the normalized data. Further, the controller service may periodically check in the database whether the job requests so received are completed or not. On completion of the job requests, the controller service may aggregate and optimize the data in the database, wherein the data may be partitioned data. The controller service may enable execution of one or more analytic techniques on the partitioned data and may provide result set of execution of the one or more analytical techniques. The controller service may create log files for execution of the one or more analytic techniques and maintain the log files for download.

In one embodiment, the controller service of the system 102 may collect online data of purchase and usage of credit, per game, from individual data banks of gaming companies owning the games. The gaming companies may be collecting user telemetry data for electronic games owned by the gaming companies, on a defined periodic interval using data collection agents. The data collection agent may be a multi-threaded independent background service responsible for fetching the data from shared company databases. The controller service on receiving a data acquisition request, may allocate a job for the data acquisition request. The controller service may further break the job into one or more tasks and may update the one or more tasks and other details related to the one or more tasks in the database. The controller service may further periodically check completion of the one or more tasks of the job in the database. The one or more tasks may be execution of one or more data retrieval queries. The results of execution of the one or more tasks may be receiving the data. The controller service on completion of the one or more tasks may aggregate and optimize the data so received as a result of execution of the one or more tasks. The controller service may validate the data in a database.

The data so collected by the controller service may be normalized and mapped into a common schema by data cleansing normalization unit 204 of the system 102. The data may be automatically normalized by the data cleansing normalization unit 204 to generate normalized data and the controller service 202 may update normalized data in analytical database 208 by the system 102. A data classification unit 206 of the system 102 may further categorize the normalized data into a plurality of categories of the electronic games in order to obtain categorized data. The data classification unit 206 may further classify the categorized data into sub-categories of the electronic games in order to obtain classified data. The data classification unit 206 of the system 102 may further partition the classified data based upon a plurality of game attributes to generate partitioned data. The controller service may update the partitioned data in the analytical database 208.

Further, the system 102 may have analytical engine 210 for executing one or more analytical techniques on the partitioned data to obtain one or more user telemetry patterns related to the in-game activities performed. The analytical techniques run on the partitioned data by the analytical engine 210 may also discover and communicate one or more patterns in the data for maximizing analytical intelligence. The one or more patterns may be user telemetry patterns. The results of the one or more patterns may further used in optimization processes in gaming industry. The in-game activities may be related to at least one of purchase and usage of in-game credit. For example, the one or more analytical techniques may be selected from k-means, Item-Based Collaborative Filtering, Statistical Mean, Correlation and the like. The one or more analytical techniques may be any analytical technique known to a person skilled in the art.

The system 102 may execute one or more analytical techniques on the partitioned data to obtain one or more user telemetry patterns related to the in-game activities performed. The one or more analytical techniques may be executed for mining the data to further identify user telemetry patterns related to purchase and usage of in-game credit in different categories of the electronic games. In one embodiment, the one or more analytical techniques run on the data may further also identify the categories, sub-categories and the game attributes showing maximum usage of game credits.

In one example, electronics games of Category War->sub-category Modern Warfare->further sub-category Multiplayer->Game attributes War equipments, for last 3 months period, the user (game players) telemetry pattern shows that game players have spent credits worth $1.7 M on purchase of ‘Shotgun’ Vs spending credits worth $1.2 M on purchase of ‘Rifle’. Above said user (game players) telemetry pattern has given an edge to ‘Shotgun’ and the gaming companies should focus on improvising ‘shotguns’ and providing the ‘shotguns’ in their electronics games, so as to leverage the user telemetry patterns so obtained and to improvise the electronic games. The improvised electronics games may result in increased user base. In another embodiment, sale of the electronics games may also be increased.

Exemplary embodiments discussed above may provide certain advantages. Though not required to practice aspects of the disclosure, these advantages may include those provided by the following features.

Some embodiments enable a system and a method for collecting data of similar category of games, across different gaming companies and different database platforms and further normalizing so collected data in a common schema.

Some embodiments enable the system and the method for providing unified database comprising data classified based on different categories, sub-categories and game attributes of electronic games.

Some embodiments enable the system and the method for providing user telemetry patterns at global usage level for defined categories of the electronic games.

Some embodiments enable the system and the method for facilitating gaming companies by providing analytics of purchase of in-game credit and usage of the in-game credit, within the game category, to optimize the electronic games to increase game revenue.

Some embodiments enable the system and the method for providing analytics that can support advertising game credit needed to play the electronics games for better gaming experience.

Some embodiments enable the system and the method for providing data analytics providing an optimized low cost credit usage in game classification to users for specific gaming categories.

Some embodiments enable the system and the method for providing more detailed, thorough, specific and accurate user telemetry pattern related to purchase and usage of in-game credit based on particular categories, sub-categories and game attributes of the electronic games.

Referring now to FIG. 3, a method 300 for analyzing data associated with electronic games is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, data associated with one or more types of the electronic games may be received from a plurality of heterogeneous data sources. The data may be related to in-game activities performed by players playing the electronic games. The data may comprise amount of in-game credit purchased for plurality of categories, sub-categories and game attributes, amount of in-game credit used for plurality of categories, sub-categories, and game attributes, geographical location of a user, region of the user, date of purchase of an electronic game, age of the user, mode of payment used while purchasing the in-game credit. In one implementation, the data associated with one or more types of the electronic games may be received by system 102 from the plurality of heterogeneous data sources. The in-game activities may be related to at least one of purchase and usage of in-game credit.

At block 304, the data may be normalized into a common schema in order to obtain normalized data. In one implementation, the data may be normalized into a common schema by the system 102 in order to obtain the normalized data. The normalization technique may be selected from 1NF, 2NF, 3NF or BCNF and the like. The normalization technique may not limit to the normalization technique listed above, and the normalization technique may comprise the normalization techniques known to a person skilled in the art.

At block 306, the normalized data may be categorized into a plurality of categories of the electronic games in order to obtain categorized data. In one implementation, the normalized data may be categorized into the plurality of categories of the electronic games by the system 102 in order to obtain the categorized data.

At block 308, the categorized data may be classified into sub-categories of the electronic games in order to obtain classified data. In one implementation, the categorized data may be classified into sub-categories of the electronic games by the system 102 in order to obtain the classified data.

At block 310, the classified data may be partitioned based upon a plurality of game attributes to generate partitioned data. In one implementation, the classified data may be partitioned based upon the plurality of game attributes by the system 102 to generate the partitioned data.

At block 312, one or more analytical techniques may be executed on the partitioned data to obtain one or more user telemetry patterns related to the in-game activities performed. In one implementation, the one or more analytical techniques may be executed on the partitioned data by the system 102 to obtain the one or more user telemetry patterns related to the in-game activities performed. The one or more analytical techniques may be selected from a group comprising k-means, Item-Based Collaborative Filtering, Statistical Mean, or Correlation, and the like. The one or more analytical techniques may not limit to the analytical techniques listed above, and the one or more analytical techniques may comprise analytical techniques known to a person skilled in the art.

Although implementations for methods and systems for analyzing data associated with electronic games have been described in language specific to structural features and/or methods, it is to be understood that the appended claims are not necessarily limited to the specific features or methods described. Rather, the specific features and methods are disclosed as examples of implementations for analyzing data associated with the electronic games.

We claim:

1. A method (300) for analyzing data associated with electronic games, the method comprising:
receiving, by a processor (110), data associated with one or more types of the electronic games from a plurality of heterogeneous data sources, wherein the data is related to in-game activities performed by players playing the electronic games;
normalizing, by the processor (110), the data into a common schema in order to obtain normalized data;
categorizing, by the processor (110), the normalized data into a plurality of categories of the electronic games in order to obtain categorized data;
classifying, by the processor (110), the categorized data into sub-categories of the electronic games in order to obtain classified data;
partitioning, by the processor (110), the classified data based upon a plurality of game attributes to generate partitioned data; and
executing, by the processor (110), one or more analytical techniques on the partitioned data to obtain one or more user telemetry patterns related to the in-game activities performed.

2. The method of claim 1, wherein the data comprises amount of in-game credit purchased for plurality of categories, sub-categories and game attributes, amount of in-game credit used for plurality of categories, sub-categories, and game attributes, geographical location of a user, region of the user, date of purchase of a game, age of the user, mode of payment used while purchasing the in-game credit.

3. The method of claim 1, wherein the in-game activities are related to at least one of purchase of in-game credit and usage of the in-game credit.

4. The method of claim 1, wherein the normalization technique is selected from at least one of 1NF, 2NF, 3NF or BCNF.

5. The method of claim 1, wherein the one or more analytical techniques are selected from a group comprising k-means, Item-Based Collaborative Filtering, Statistical Mean, or Correlation.

6. A system (102) for analyzing data associated with electronic games, the system comprising:
a processor (110); and
a memory (114) coupled to the processor, wherein the processor is capable of executing programmed instructions stored in the memory to:
receive data associated with one or more types of electronic games from a plurality of heterogeneous data sources, wherein the data is related to in-game activities performed by players playing the electronic games;
normalize the data into a common schema in order to obtain normalized data;
categorize the normalized data into a plurality of categories of electronic games in order to obtain categorized data;
classify the categorized data into sub-categories of the electronic games in order to obtain classified data;
partition the classified data based upon a plurality of game attributes to generate partitioned data; and
execute one or more analytical techniques on the partitioned data to obtain one or more user telemetry patterns related to the in-game activities performed.

7. The system (102) of claim 6, wherein the data comprises 1) amount of in-game credit purchased for plurality of categories, sub-categories and game attributes, 2) amount of in-game credit used for plurality of categories, sub-categories, and game attributes, 3) geographical location of a user, 4) region of the user, 5) date of purchase of a game, 6) age of the user, 7) mode of payment used while purchasing the in-game credit.

8. The system (102) of claim 6, wherein the in-game activities are related to at least one of purchase and usage of in-game credit.

9. A non transitory computer readable medium having embodied thereon a computer program executed in a computing device for analyzing data associated with electronic games, the computer program product comprising:
a program code for receiving data associated with one or more types of electronic games from a plurality of heterogeneous data sources, wherein the data is related to in-game activities performed by players playing the electronic games;
a program code for normalizing the data into a common schema in order to obtain normalized data;
a program code for categorizing the normalized data into a plurality of categories of electronic games in order to obtain categorized data;
a program code for classifying the categorized data into sub-categories of the electronic games in order to obtain classified data;
a program code for partitioning the classified data based upon a plurality of game attributes to generate partitioned data; and
a program code for executing one or more analytical techniques on the partitioned data to obtain one or more user telemetry patterns related to the in-game activities performed.
